(19) United States
(12) Patent Application Publication
(10) Pub. No.: US 2010/0300223 A1
(43) Pub. Date: Dec. 2, 2010

(54) SYSTEMS FOR RECIPROCAL MOTION IN WAVE TURBINES

(76) Inventor: Daniel Farb, Beit Shemesh (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/745,547

(22) PCT Filed: Nov. 30, 2008
(86) PCT No.: PCT/IB08/55015

§ 371 Date: May 31, 2010

Related U.S. Application Data
(60) Provisional application No. 60/991,789, filed on Dec. 3, 2007.
(60) Provisional application No. 61/017,816, filed on Dec. 31, 2007.
(60) Provisional application No. 61/028,545, filed on Feb. 14, 2008.
(60) Provisional application No. 61/043,138, filed on Apr. 8, 2008.
(60) Provisional application No. 61/058,235, filed on Jun. 3, 2008.

(51) Int. Cl. F16H 19/04; F16H 1/02

(52) U.S. Cl. 74/35; 74/730.1; 74/34

(57) ABSTRACT

Systems and methods for obtaining power from reciprocal motion, particularly for waves, are presented.

This patent application claims The benefit of U.S. Provisional Patent Application No. 60/991,789, Wind, Wave, and Water Renewable Energy Elaborations, filed Dec. 3, 2007; 61/017,816, Hydro Turbines, Portable Wind, Waves, and Magnets, filed Dec. 31, 2007; 61/028,545, Provisional 2-08: One-directional bearings, Large and Small Wind, Hydro, Blade Design, Feb. 14, 2008; 61/043,138, Provisional 4-08 Couplings-FDD-Gears, Apr. 8, 2008; 61/058235, Provisional 6-08: Improvements to renewable energy devices, Jun. 3, 2008.

### FIELD AND BACKGROUND OF THE INVENTION

The present invention relates to making use of the back and forth motion in some energy systems, particularly that for waves. There are other situations, such as reversing water flows and tides, where such a system can be effective. An earlier PCT by the same author, PCT Small Wave Configurations, illustrated (in FIG. 3 there) the concept of using a rack with wave motion, but without showing any details. The specification there reads, “FIG. 3 shows another device for obtaining electrical energy from the vertical motion of waves. Attached to the vertical pole (16) is a rack (17) and gear (18) system with an enclosed generator, said rack attached to a pile or pile-like structure (16).” The following claims are relevant:

4. The system of claim 1, wherein the generator means comprises a rack and gear.

16. A vertical wave energy generating system, comprising:

a. a vertical pole,
b. a rack attached to said vertical pole,
c. a gear attached to the rack and the turbine.

17. The system of claim 16, further comprising:

d. at least one vertical stop for the turbine and its attachments.

The current application deals with specifics of such a system

### BRIEF DESCRIPTION OF THE DRAWINGS

The invention is herein described, by way of example only, with reference to the accompanying drawings, wherein:

FIG. 1 is a diagram of a clutch-transmission-gear concept for reciprocal motion.

FIG. 2 is a diagram of a bevel gear concept for reciprocal motion.

FIG. 3 is a diagram of a clutch-transmission-gear concept for reciprocal motion downward.

FIG. 4 is a diagram of a clutch-transmission-gear concept for reciprocal motion downward in more detail.

FIG. 5 is a diagram of torque transfer in a clutch-transmission-gear concept for reciprocal motion.

FIG. 6 is a diagram of a clutch-transmission-gear concept for reciprocal motion upward.

FIG. 7 is a diagram of a detail of a clutch-transmission-gear concept for reciprocal motion upward.

FIG. 8 is a diagram of a clutch-transmission-gear concept for reciprocal motion upward at return to starting position.

FIG. 9 is a diagram of a clutch-transmission-gear concept for reciprocal motion in a gear box.

FIG. 10 is a diagram of a clutch-transmission-gear concept for reciprocal motion in a gear box in detail.

### DESCRIPTION OF THE PREFERRED EMBODIMENTS

The present invention relates to reciprocal motion systems, particularly for waves, but also for other systems, such as water moving in opposite directions through a tidal turbine or pump. So the input motion may be back and forth, of which a variant may be up and down.

Definitions:

Reciprocating motion: a back and forth motion which repeats over and over again

Clutch: a coupling that connects or disconnects driving and driven parts of a driving mechanism. Or: a mechanism for transmitting rotation, which can be engaged and disengaged.

Transmission: system of gears and chains by which power is transmitted

Freewheel: a device that allows gears to turn freely.

The principles and operation of a gear system to enable reciprocating motion according to the present invention may be better understood with reference to the drawings and the accompanying description.

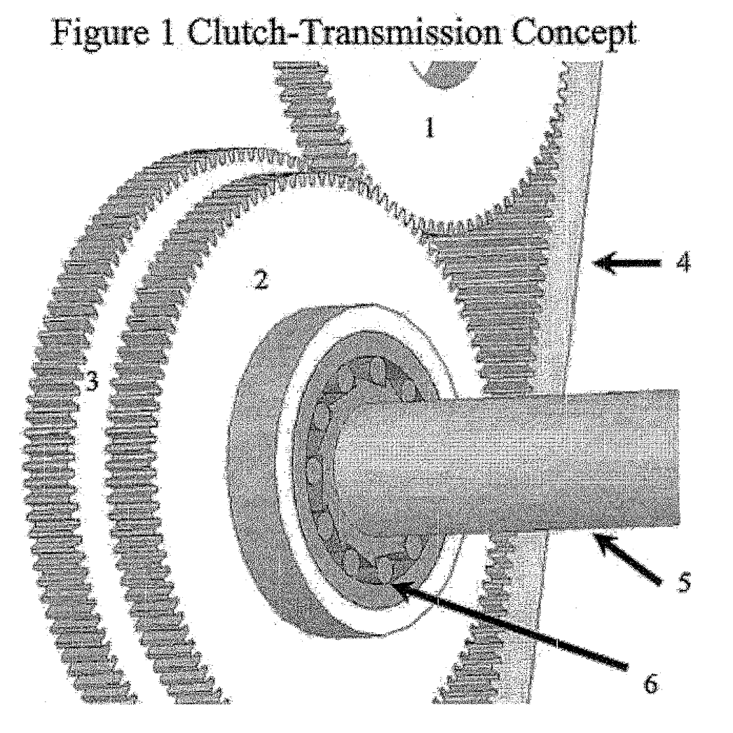

Referring now to the drawings, FIG. 1 illustrates a reciprocating motion gear whose output is unidirectional but whose input is bidirectional, as in the bidirectional motion of waves. The application shown is a rack vertical mechanism. It is not restricted to the vertical or to use on a rack; this is merely one embodiment. A gear (1) slides along a rack (4) and turns a second freewheel gear (2) not attached to the rack. Gear (2) contains a clutch that connects to the generator shaft (5) and to gear (3). The numbers for these parts will be the same for the regular gear pictures that follow.

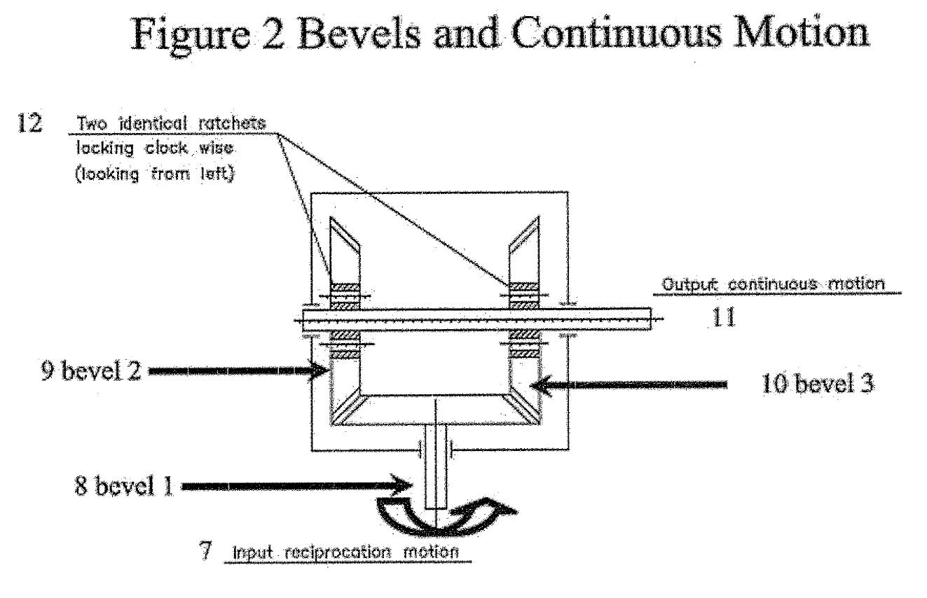

FIG. 2 is a diagram of a bevel gear concept for reciprocal motion. It shows motion input on the bottom (7) from either of two rotational directions. It then leads to a bevel gear (8) that connects to two other bevel gears (9, 10) and at least two ratchets (12) that produce continuous motion in one direction on a shaft (11) that connects to a generator. That rotation can produce power from use with any kind of generator, ideally a permanent magnet generator.

Another new use of this concept is with a pump or hydroelectric turbine, in one embodiment a Benkatina in-pipe turbine. That enables it to be fixed in one position and generate electricity from tidal movements in opposite directions, or to function as a pump by rotating in reverse in response to a power input.

Here is introduced the use of reciprocating motion, with circular or bevel gear systems, and any other reciprocating motion system, with rotational wave motion, underwater currents, and wind machines, with or without a rack.

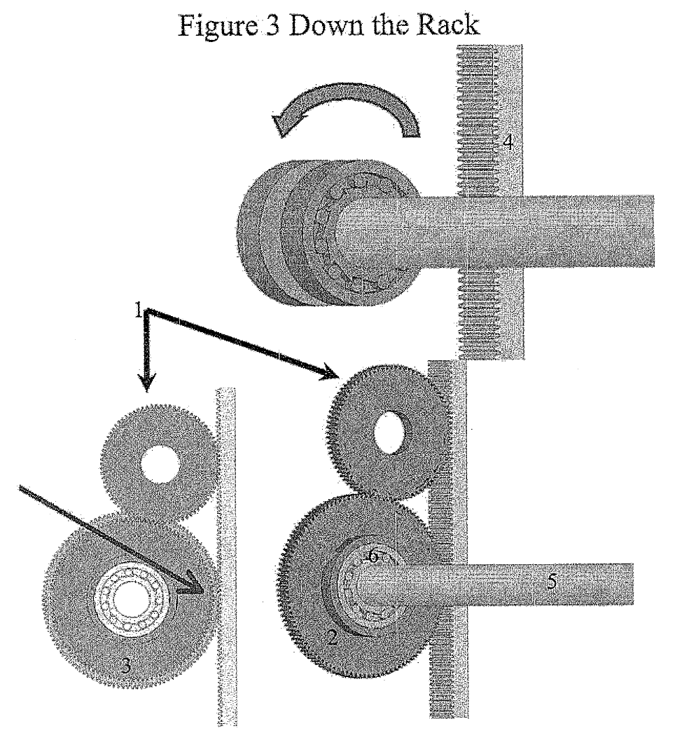

FIGS. 3-8 show in detail the use of a one-directional clutch-transmission for several renewable energy applications. A one-directional clutch-transmission has the ability to transfer the torque in one direction and enable free motion in the other direction. Using a rack is one way of doing this, but the invention is not limited to a rack system. The rack may be straight, as in the illustrations, or curved. The essential parts are a freewheel attached to a ratchet and two other gears, only one of the two other gears connecting to the rack (or source of movement).

FIG. 3 is a diagram of a clutch-transmission-gear concept for reciprocal motion downward. As gear (1) rolls downwards, the freewheel (2) with the ratchet rolls freely. Gear (3) also drives the generator shaft (5) on the way down. Note the gear (2) does not touch the rack. This fact helps to change direction without disturbing the biggest gear's work.

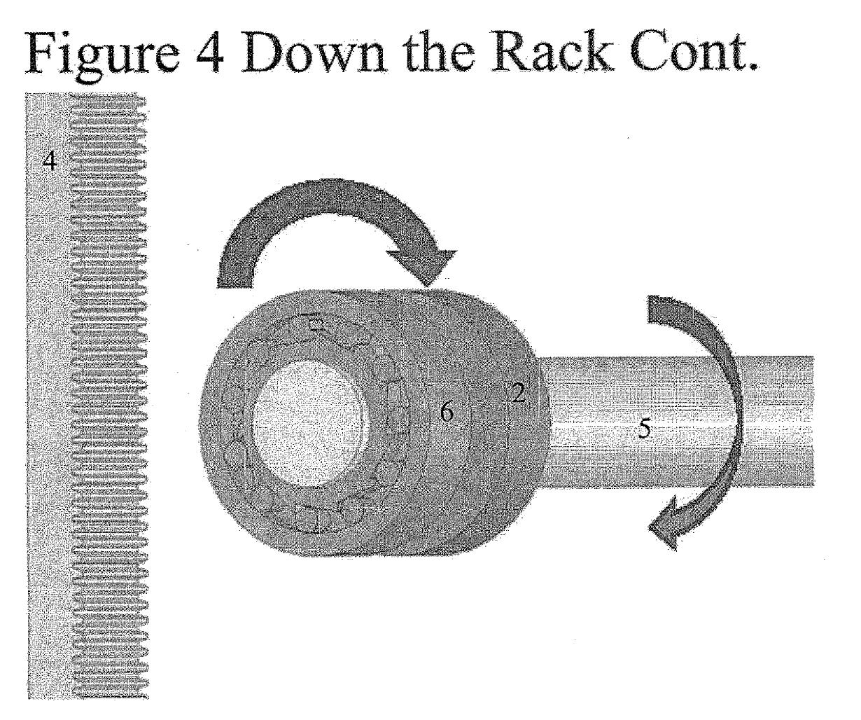

FIG. 4 is a diagram of a clutch-transmission-gear concept for reciprocal motion downward in more detail.

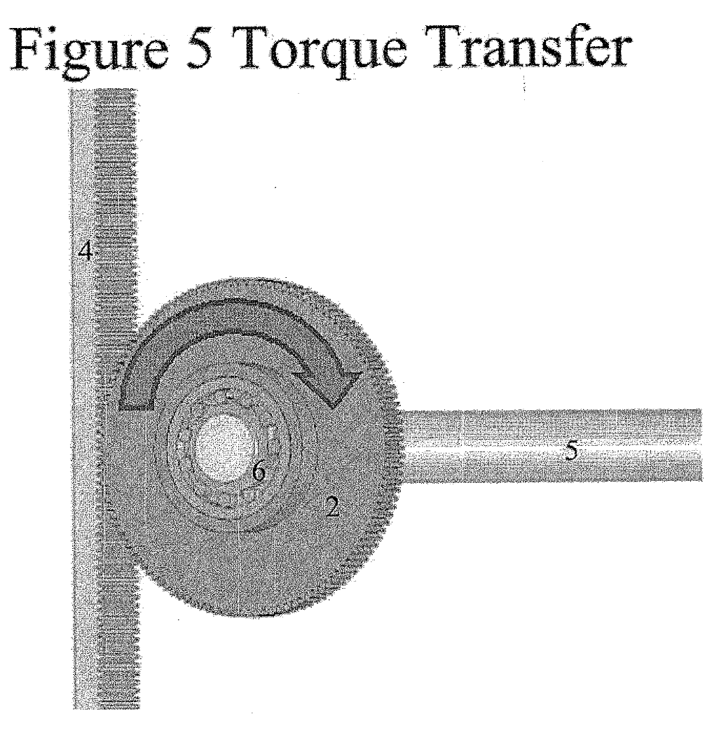

FIG. 5 is a diagram of torque transfer in a clutch-transmission-gear concept for reciprocal motion. The gear/ratchet (6) transfers torque to the generator shaft only to the direction indicated.

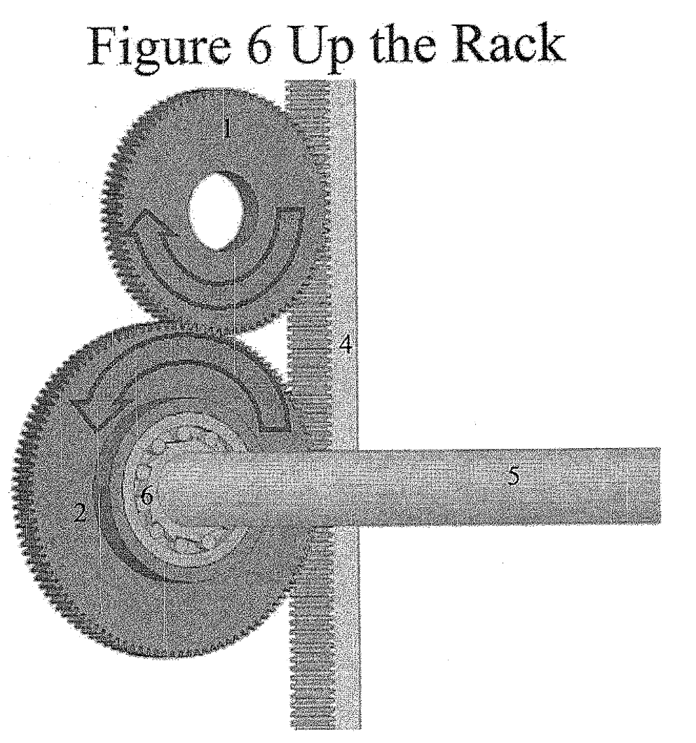

FIG. 6 is a diagram of a clutch-transmission-gear concept for reciprocal motion upward.

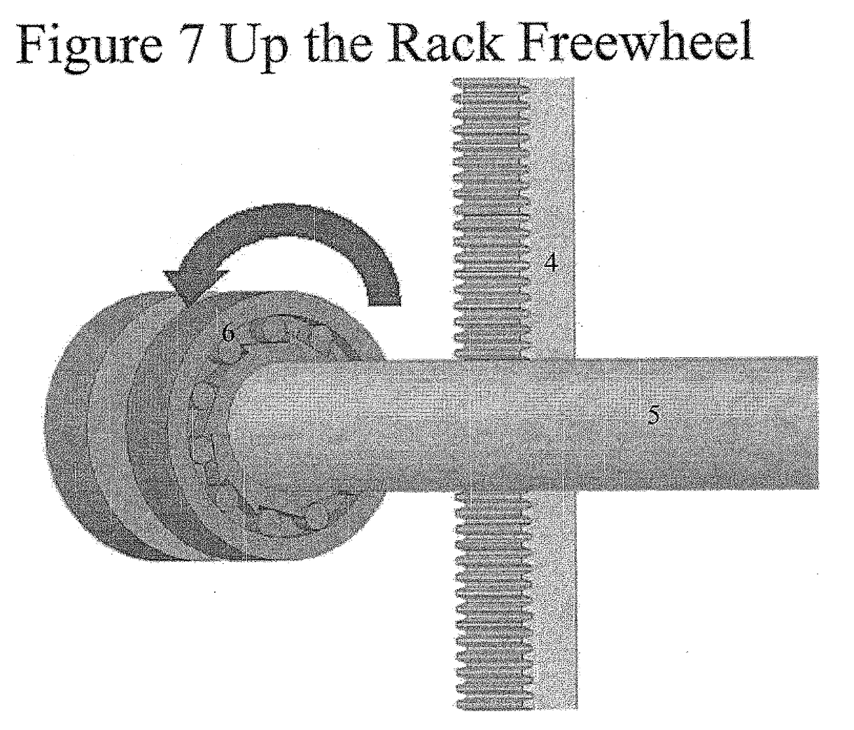

FIG. 7 is a diagram of a detail of a clutch-transmission-gear concept for reciprocal motion upward.

The way up starts with gear (1) and (2) rolling on the rack as indicated. The gear transfers through the freewheel (2) the rotation to the generator axis. This way the generator axis keeps rolling in one direction of rotation.

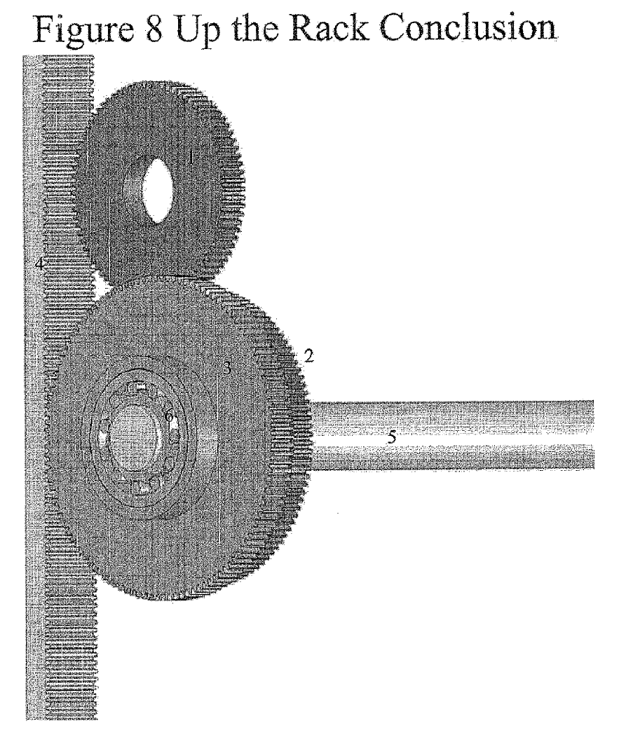

FIG. 8 is a diagram of a clutch-transmission-gear concept for reciprocal motion upward at return to starting position. On the way up the freewheel (3) does not transfer any torque and rolls freely as the freewheel cannot transfer the torque. Gears (1) and (2) do the job this way. Note that gear (2) does not touch the rack and rotates the opposite way from gear (3) because it interfaces with gear (1).

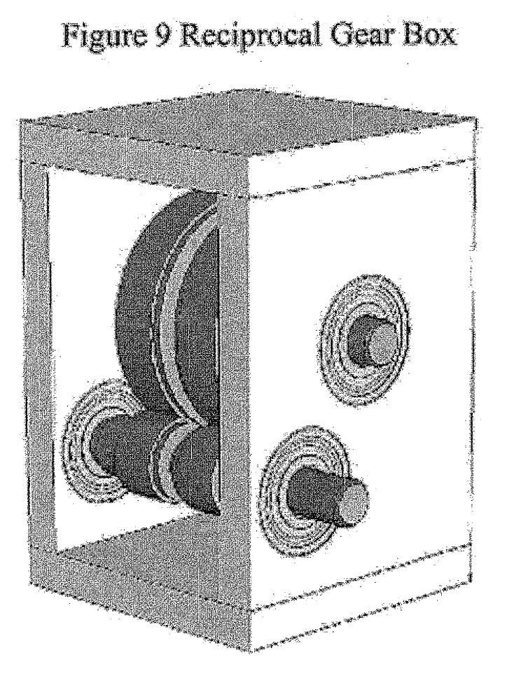

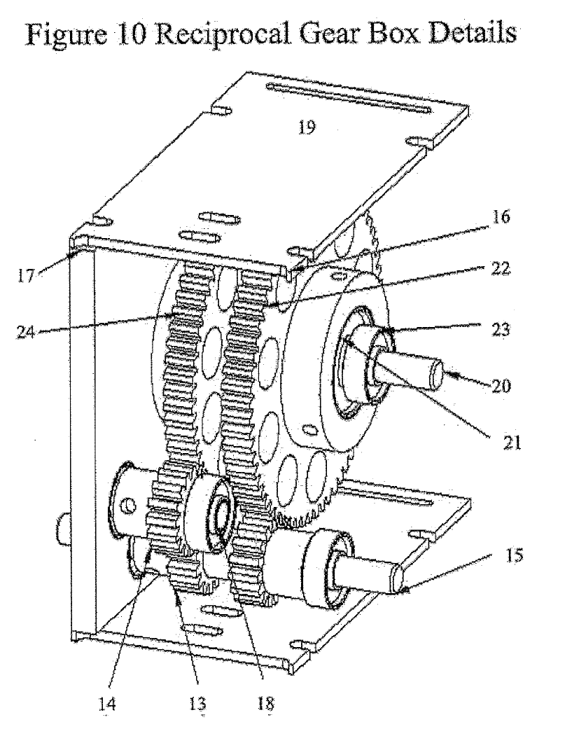

FIG. 9 is a diagram of the outside of a clutch-transmission-gear concept for reciprocal motion in a gearbox. The details are in FIG. 10.

FIG. 10 is a diagram of a clutch-transmission-gear concept for reciprocal motion in a gearbox in detail. (20) is the input torque shaft. As that moves clockwise, it drives freewheel (21) in the hub of gear (22), which transfers torque to small gear (14) on output torque shaft (15). When moving counter-clockwise, the input torque shaft (20) drives torque to freewheel (21) inside gear hub (24), which drives the idle gear (14) on shaft (18), which turns gear (13) on output shaft (15). Bearings (23) support shafts (15, 18, 23). Housing pieces (16), (17), and (19) hold everything in place.

Another innovation, not illustrated, is to make the rotational motion of wave surface paddles back and forth, rather than continuous. In that case, a reciprocal motion system may be added to make the motion presented to the generator continuous in one direction. A system for the same purpose may also be used in any back and forth motion in any wave system, or any energy system. An alternative method and device would be means to make use of the reversed polarity of the output.

Making the gears of plastic can decrease the weight tremendously.

The reciprocating motion system can be used for both the vertical motion and the rotational motion of a wave turbine at the same time.

While the invention has been described with respect to a limited number of embodiments, it will be appreciated that many variations, modifications and other applications of the invention may be made.

### SUMMARY OF THE INVENTION

The present invention successfully addresses the shortcomings of the presently known configurations by providing a reciprocating motion gear solution to produce unidirectional motion for a generator.

It is now disclosed for the first time a fluid energy system, comprising:

a. a clutch-gear-transmission system for output of unidirectional motion from bidirectional motion.

According to another embodiment, the fluid energy system is rotational in waves.

According to another embodiment, the fluid energy system is linear in waves.

According to another embodiment, the fluid energy system is a gas. According to another embodiment, the gas is wind, and the bidirectional motion occurs from flapping of a wind collector.

According to another embodiment, the transmission system operates on a linear rack.

According to another embodiment, the transmission system operates on a curved rack.

According to another embodiment, the transmission system comprises at least one beveled gear.

According to another embodiment, the input motion is substantially vertical.

According to another embodiment, the input motion is substantially horizontal.

It is now disclosed for the first time a clutch-gear-transmission system for output of unidirectional motion from bidirectional motion, comprising:

a. three gears, at least one of which is a freewheel.

It is now disclosed for the first time a method for obtaining unidirectional motion from the back and forth rotational motion of waves, comprising a clutch-gear-transmission system.

It is now disclosed for the first time a method for obtaining unidirectional motion from the back and forth vertical motion of waves, comprising a clutch-gear-transmission system.

It is now disclosed for the first time a method for obtaining unidirectional motion from the back and forth vertical motion of waves and the back and forth rotational motion of waves simultaneously, comprising a clutch-gear-transmission system.

It is now disclosed for the first time a clutch-gear-transmission system for output of unidirectional motion from bidirectional motion, wherein at least one gear is plastic.

It is now disclosed for the first time a reciprocating motion system, comprising:

a. a rack,
b. a first gear, interfacing with the rack,
c. a second gear, not attached to the rack, a freewheel,
d. a clutch, connected to the second gear and to a generator shaft,
e. a third gear, connected to the clutch.

It is now disclosed for the first time a reciprocating motion system, comprising:

a. a first bevel gear,
b. a second and third bevel gear, each interfacing with the first bevel gear,
c. a first ratchet connected to the second gear,
d. a second ratchet connected to the third gear,
e. a shaft, connected to a generator and to the second and third gears.

It is now disclosed for the first time a reciprocating motion system, comprising:

a. an input torque shaft with a first gear and a second freewheel gear and a hub with a clutch,
b. a third gear interfacing with the second gear and located on a separate shaft,
c. an output torque shaft comprising a fourth gear interfacing with the first gear, and comprising a fifth gear, interfacing with the third gear.

What is claimed is:

1-18. (canceled)

19. A fluid energy system, comprising:
a. A clutch-gear-transmission system comprising at least one freewheel for output of unidirectional motion from bidirectional motion.

20. The system of claim 19, wherein the fluid energy system is rotational in waves.

21. The system of claim 19, wherein the fluid energy system is linear in waves.

22. The system of claim 21, wherein a rotational energy system operates simultaneously.

23. The system of claim 19, wherein the fluid energy system is a gas.

24. The system of claim 19, wherein the transmission system operates on a linear rack.

25. The system of claim 19, wherein the transmission system operates on a curved rack.

26. The system of claim 19, wherein the input motion is substantially vertical.

27. The system of claim 19, wherein the input motion is substantially horizontal.

28. The system of claim 19, wherein at least one gear is plastic.

29. A fluid energy system, comprising:
a. A clutch-gear-transmission system, wherein the input transmission system comprises at least one beveled gear.

30. The system of claim 29, wherein the system is used in waves.

31. A reciprocating motion system, comprising:
a. A rack,
b. A first gear, interfacing with the rack,
c. A second gear, not attached to the rack, a freewheel,
d. A clutch, connected to the second gear and to a generator shaft,
e. A third gear, connected to the clutch.

32. A reciprocating motion system, comprising:
a. A first bevel gear,
b. A second and third bevel gear, each interfacing with the first bevel gear,
c. A first ratchet connected to the second gear,
d. A second ratchet connected to the third gear,
e. A shaft, connected to a generator and to the second and third gears.

33. A reciprocating motion system, comprising:
a. An input torque shaft with a first gear and a second freewheel gear and a hub with a clutch,
b. A third gear interfacing with the second gear and located on a separate shaft,
c. An output torque shaft comprising a fourth gear interfacing with the first gear, and comprising a fifth gear, interfacing with the third gear.
